(19) United States
(12) Patent Application Publication
(10) Pub. No.: US 2009/0292661 A1
(43) Pub. Date: Nov. 26, 2009

(54) Compact Circuits and Adaptation Techniques for Implementing Adaptive Neurons and Synapses with Spike Timing Dependent Plasticity (STDP).

(76) Inventor: Alfred M. Haas, Hyattsville, MD (US)

Correspondence Address: Alfred M. Haas, 3410 Tulane Drive, Apt. 31, Hyattsville, MD, 20783, US

(21) Appl. No.: 12/470,468

(22) Filed: May 21, 2009

Related U.S. Application Data
(60) Provisional application No. 61/055,011, filed on May 21, 2008.

(51) Int. Cl. G06N 3/063

(52) U.S. Cl. 706/33

(57) ABSTRACT

This invention pertains to compact synaptic circuits and networks comprising compact synaptic circuits that exhibit functional characteristics of biological synapses and networks of synapses including, but not limited to, spike timing dependent plasticity (“STDP”). Temporal coincidence of pre- and post-synaptic action potentials across the synapses of the present invention induces proportional Hebbian synaptic weight updates. Networks of the synapses of the present invention operated according to the methods of this invention are designed to implement biological learning functions, such as STDP.

### CROSS-REFERENCE TO RELATED APPLICATIONS

Pursuant to 35 USC § 119(e) and as set forth in the Application Data Sheet, this utility application claims the benefit of priority from U.S. Provisional Patent Application No. U.S. 61/055,011, which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

In biology, spike-timing-dependent-plasticity (“STDP”) describes the potentiation or depression of synaptic connections between neurons according to the coincidence of pre and post-synaptic action potentials. More specifically, it has been experimentally observed that when an action potential transmitted by a pre-synaptic neuron across a synapse to a post-synaptic neuron is followed within some time window (typically on the order of ms) by the firing of an action potential by the post-synaptic neuron, then the strength of the synaptic connection between the two neurons is increased in proportion to the coincidence of the firing times (or equivalently in inverse proportion to the time between firings). Conversely, it has been shown that when an action potential transmitted by a pre-synaptic neuron across a synapse to a post-synaptic neuron follows within some time window (typically on the order of ms) the firing of an action potential in the post-synaptic neuron, then the strength of the synaptic connection between the two neurons is decreased in proportion to the coincidence of the firing times (or equivalently in inverse proportion to the time between firings). These rules which govern the magnitudes of potentiation and depression of synaptic weights and which together give rise to STDP, are respectively given the names Hebbian and anti-Hebbian learning, after Donald Hebb, the person who first described them. FIG. 1 shows biologically measured STDP as reported in [1] R. Froemke, Y. Dan Y, “Spike-timing-dependent synaptic modification induced by natural spike trains,” Nature, vol. 416, March 2002, pp. 433-438, and [2] Y. Dan, M. Poo, “Spike timing-dependent plasticity: from synapse to perception,” Physiol. Rev., vol. 86, no. 3, pp. 1033-048, July 2006, which are herein incorporated by reference.

For hundreds of years, man has been attempting to replicate the computational power of the human brain. As one step down that path, there exists a need for compact, densely integrated (The phrase “densely integrated” is defined broadly in this application to mean densely spatially integrated, as for example an integrated circuit or other micro- or nano-array may be densely integrated. The phrase “densely integrated” is specifically not intended to be construed as limited to integrated circuits—it also describes other micro- or nano-electrode arrays, memristor arrays, polymer electrode arrays, carbon nano-tube (“CNT”) arrays, etc.) neural networks comprising very small synapses for implementing powerful hardware networks capable of learning.

There is also a general need to reduce the size, power consumption and design complexity of the aforementioned synapses and the neural networks comprising these synapses to the extent possible in order to increase the density and computational power of these networks; to permit operation in environments where excessive heat dissipation or other EM radiation from, e.g., rapid circuit switching operations, is unacceptable, for example in neural implants; to extend battery-powered electrode sensor array lifetimes; to reduce overall costs; and for other reasons understood by those of skill in the art.

In addition, there is a particular need for compact synaptic and neural network circuits that can meet the aforementioned needs without consuming the excess power, time, and size overhead required by systems which need to repeatedly and rapidly update their synaptic weights or data onto small integrated capacitors, and/or which require additional circuitry, including microcontrollers or other systems, external to the electrode array to maintain a memory of the learned events.

The text by J. Baker, “CMOS Circuit Design, Layout and Simulation,” 2d Edition, Copyright 2005, Institute for Electrical and Electronics Engineers, Inc. (“IEEE”), and published by the IEEE and Wiley-Interscience (“the Baker text”) discloses fundamentals of integrated CMOS circuit design at the level of an undergraduate university course. In addition, the text “Floating Gate Devices: Operation and Compact Modeling” by P. Pavan, L. Larcher, and A. Marmiroli, Copyright 2004, Kluwer Academic Publishers, Inc., (“the FG text”) discloses information about the physics and general operation of floating gate devices. As one clarification, in this specification, we define “non-volatile analog memories” broadly to include floating gate devices, but also according to the plain and ordinary meaning of the words to include other analog memory devices that exhibit non-volatile storage, for example memristors, chalcogenides, organic and inorganic polymers, and carbon nano-tubes.

The discussion of the background of the invention herein is included to explain the context of the invention. Although each of the patents and publications cited herein are hereby incorporated by reference, neither the discussion of the background nor the incorporation by reference is to be taken as an admission that any of the material referred to was published, known, or part of the common general knowledge as at the priority date of any of the claims.

### BRIEF SUMMARY OF THE INVENTION

The invention disclosed herein comprises compact synaptic circuits and networks of synaptic circuits that exhibit functional characteristics of biological synapses and networks of synapses including, but not limited to, spike timing dependent plasticity (“STDP”). Temporal coincidence of pre- and post-synaptic action potentials across the synapses of the present invention induces proportional Hebbian synaptic weight updates. In the absence of correlated pre- and postsynaptic activity, no significant weight updates occur. Integrated circuit realizations of this invention include, but are not limited to, two-transistor MOSFET synapses and memristor synapses which exhibit STDP when operated according to the methods of the invention. Suitable synthetic neural waveforms for implementing STDP have been derived and are disclosed herein.

### BRIEF DESCRIPTION OF THE SEVERAL VIEWS OF THE DRAWING

FIG. 1 represents biological STDP and is copied from R. Froemke, Y. Dan Y, “Spike-timing-dependent synaptic modification induced by natural spike trains,” Nature, vol. 416, March 2002, pp. 433-438, and Y. Dan, M. Poo, “Spike timing-dependent plasticity: from synapse to perception,” Physiol. Rev., vol. 86, no. 3, pp. 1033-048, July 2006.

FIG. 2 represents one embodiment of the synaptic circuits of the present invention, a two-transistor MOSFET synapse (“2TS”) that comprises two p-type MOSFETs (“PFET”) transistors.

FIG. 3 represents idealized “pre-” and “post-” synaptic waveforms for generating STDP across the 2TS and also across memristor synapses.

FIG. 4 illustrates one mechanism for implementing positive Hebbian weight updates for the 2TS class of circuits.

FIG. 5 illustrates one mechanism of implementing negative Hebbian weight updates for the 2TS class of circuits.

FIG. 6 represents a computation of theoretical weight updates resulting from different coincidences of idealized pre- and post-synaptic waveforms across one embodiment of the 2TS class of synapses.

FIG. 7 represents a theoretical learning and pattern recognition neural network according to one embodiment of the present invention whose architecture corresponds roughly with fabricated circuit components.

### DETAILED DESCRIPTION OF THE INVENTION

We disclose novel integrated circuits and techniques for high density realizations of synthetic neural systems that implement STDP by Hebbian learning. The novel synaptic circuits include, but are not limited to one or more of the following circuits comprising: (A) a pair of field effect transistors which share a common floating gate whose voltage may be updated by tunneling and/or injecting current onto the floating node; tunneling and injection, in turn, may be accomplished by modulating the voltages applied and/or electrically coupled to one or more of the terminals (sources, drains, gates and/or bulks) of the transistors and/or by modulating the corresponding currents between the various transistor terminals; (B) a single field effect transistor with a gate that is electrically and/or physically coupled to the storage node of a non-volatile memory (such as a CMOS electrically isolated poly gate, or a quantum dot between two nanowires of a conductive crossbar—the memory could also be exotic, such as magnetic or otherwise, as with all the devices disclosed herein) which is electrically and/or physically coupled (capacitively, inductively, chemically or otherwise) to two or more contacts for asserting an electrical control signal input, as described in greater detail below and in some supporting materials; (C) an active resistive element (see Wang, et al., Resistive Switching Mechanism in ZnxCd1−xS Nonvolatile Memory Devices, IEEE Electron Device Letters, v. 28 no. 1, January 2007, incorporated herein by reference) which can switch between two or more states as a function of applied electrical signals asserted across the device, and the additional neural control circuitry required to generate the adaptive weight updates, as described in greater detail herein. Memristors fall into this class of circuit.

This disclosure is not intended to limit the inventions to a specific process or technology. For example, the circuit transistors, resistors, capacitors, diodes, and other active and passive devices of the inventions may be fabricated using conventional integrated circuit technologies (e.g., CMOS, BiCMOS) and also with newer technologies, including but not limited to stacked tunneling junctions, amorphous-Si transistors, quantum dots, nanowire transistors, junctions and resistive elements, memristors and related technology, chalcogenides, ferroelectric resistive elements, colloidal suspensions of nanoparticles, and other materials and devices known to those of ordinary skill in the art. Furthermore, integrated circuits for generating arbitrary, repeating voltage and current waveforms, including waveforms corresponding with the shape, instantiation and inter-spike interval of biological action potentials, including those by G. Indiveri, R. Douglas, and C. Mead, have been fabricated and characterized and are known to those of skill in the art.

The novel adaptive techniques disclosed correspond to the devices and circuit technologies employed to implement synaptic weight updates and/or STDP. Where the circuits are used as synaptic elements, they serve two primary functions: (1) provide a feedforward signal to the postsynaptic neuron, and (2) implement STDP based on the presynaptic and postsynaptic waveforms. For the circuits in (A) above, waveforms are asserted onto the appropriate terminals of the two transistors to implement balanced tunneling and injection and the desired STDP characteristic. As disclosed in the incorporated materials, balanced tunneling and injection may be attained by a uniphasic pre- and biphasic postsynaptic set of neural signal waveforms, and/or by matched biphasic waveforms generated by circuitry known to those of skill in the art.

It should be noted that the disclosed aspects of operation of these circuits is not intended to confine the inventions to a prescribed set of inputs or biases; operation of the circuits in different contexts may require different biases and inputs than those specifically identified here, and this is understood by one of ordinary skill in the art.

In building complex neural systems from the circuits described above, it is recognized that the artificial neurons used depend upon the synapses used, and vice-versa. In one implementation, the ultra-compact (one to four devices) synaptic architectures described may be used, along with integrated circuit neurons to build a neuromorphic adaptive system. In this context, the neurons may take on one or more of several responsibilities: (a) communicating with one another on biologically realistic or faster time scales; (b) generating desired control waveforms to implement Hebbian learning; (c) sensing and/or integrating the current passing through a device; and/or (d) clamping the voltage at the sensing node.

Architectures for accomplishing these tasks using integrated devices, including nanotech are known to those of skill in the art. In particular, it is possible to simply have an integrate and fire neuron generate arbitrary shaped spikes corresponding to biological action potentials at biologically realistic or shorter time intervals and scale, and to then integrate that same signal onto an output capacitor or buffer it through slightly more complicated circuitry to reshape and rescale the pulse to generate the long time scale input to the synapse for implementing STDP by Hebbian and learning. Likewise, single-electrode voltage-clamping, current-sensing circuits are well known, for example as implemented in Axon Corporation's patch-clamp amplifiers and headstages. Similarly, it is possible to keep neurons simple integrate-and-fire or other architectures, and to locally generate the weight update waveform and/or implement long-time-scale coincidence detectors, such as those described in the modified Indiveri circuit. Network level architectures such as buffers or repeaters may also be incorporated at the system level, using techniques known to those of skill in the art. This disclosure is intended to be understood by a person of ordinary skill in the art—in this case that means a neuromorphic engineer with some understanding of nanoelectronics and device physics.

The basic idea behind the class of integrated synapse circuits comprising two transistors with spike-timing-dependent-plasticity (“STDP”), is that the pre- and post-synaptic action potentials (“spikes”) control the weight updates of the synapse and current injection to the postsynaptic integration node. In one embodiment, the pre-synaptic spikes are coupled to the source and body of a PMOS transistor whose drain is coupled to the post-synaptic spikes, and whose floating gate is tied to the gate of a 2nd PMOS transistor whose source is: (a) also connected to PRE; and/or (b) to a supply voltage, and whose drain is the post-synaptic integration node. PRE may also be coupled directly to the common floating node, and in any case it may be advantageous to have the pre-synaptic spikes at a significant DC offset, but with a smaller transient spike amplitude than POST.

In this class of embodiments, if the pre-synaptic waveform (“PRE”) is unipolar, and the postsynaptic waveform (“POST”) is biphasic, then when: (a) PRE occurs first, but POST occurs within some prescribed time of PRE, then PRE and POST will overlap at a high voltage causing Fowler-Nordheim tunneling to increase the stored voltage on the floating gate and thereby increase the synaptic weight; on the other hand, when (b) POST occurs first, but PRE occurs within some prescribed time of POST, then PRE and POST will overlap resulting in a large difference in the source-drain voltage causing hot electron injection to decrease the stored voltage on the floating gate and thereby decrease the synaptic weight. In any case, you could separate the positive and negative phases of the post-synaptic spikes so that PRE could only overlap with one phase of POST at a time, or you could allow for the possibility of both tunneling and injection across a single region of overlapping PRE and POST waveforms.

For biphasic waveforms, the operation of the 2TS circuit is relatively straightforward in theory. PRE and POST synaptic waveforms are asserted at the corresponding labeled nodes. If PRE occurs first, but POST occurs within some prescribed time of PRE, then PRE and POST will overlap resulting in a large transient difference in the source-drain voltage of the programming transistor causing hot electron injection to decrease the stored voltage on the floating gate and thereby increase the synaptic weight. On the other hand, when POST occurs first, but PRE occurs within some prescribed time of POST, then PRE and POST will overlap at a high voltage causing Fowler-Nordheim tunneling to increase the stored voltage on the floating gate and thereby decrease the synaptic weight.

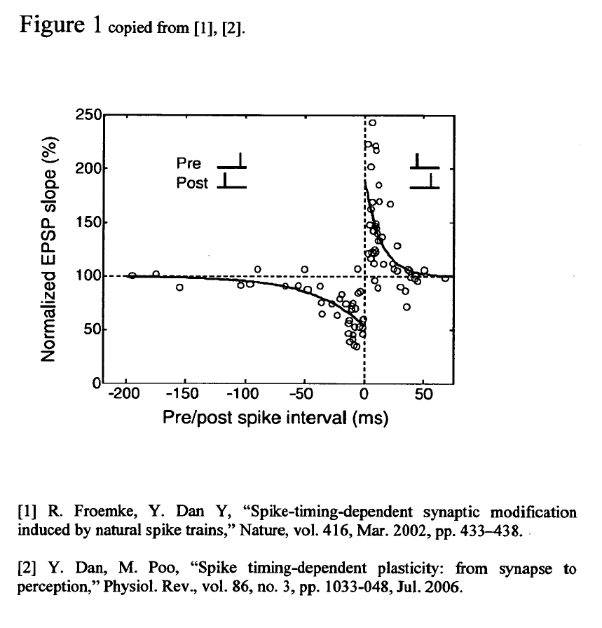

Although it is not believed that drawings are necessary for the understanding of the subject matter sought to be patented, for illustrative purposes we have included seven figures. FIG. 1 represents biological STDP and is copied from R. Froemke, Y. Dan Y, “Spike-timing-dependent synaptic modification induced by natural spike trains,” Nature, vol. 416, March 2002, pp. 433-438, and Y. Dan, M. Poo, “Spike timing-dependent plasticity: from synapse to perception,” Physiol. Rev., vol. 86, no. 3, pp. 1033-048, July 2006.

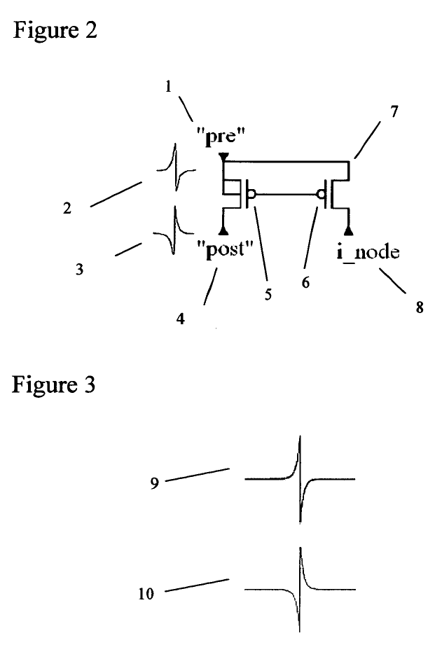

FIG. 2 represents one embodiment of the synaptic circuits of the present invention, a two-transistor MOSFET synapse (“2TS”) that comprises two p-type MOSFETs (“PFET”) transistors with a floating node that electrically and/or physically connects the gate of the left (5) and the gate of the right (6) PFETs. In this figure, a cartoon “pre”-synaptic signal (2) is asserted at PFET sources (1) and (7) which are schematically illustrated as electrically and/or physically connected to one another. Similarly, in the figure, the cartoon “post”-synaptic signal (3) defines the potential of the drain of the PFET on the left (4). The PFET on the right passes current generated by “pre”-synaptic spikes (1) to the integration node (8), or soma, of the post-synaptic neuron (not shown). The body of the transistor on the left is connected to the source (1), while the body of the right transistor (not schematically represented) may be held at a fixed potential.

FIG. 3 represents idealized “pre-” (9) and “post-” (10) synaptic waveforms for generating STDP across the 2TS and also across memristor synapses. Various modifications to these classes of waveforms, which would be apparent to one of skill in the art, may be made without departing from the invention.

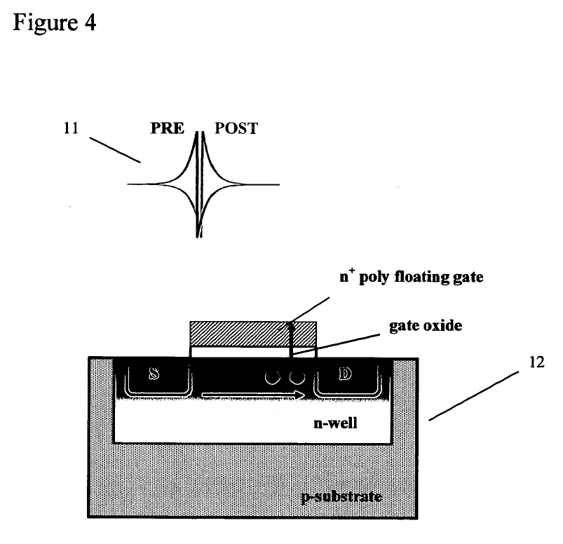

FIG. 4 illustrates one mechanism for implementing positive Hebbian weight updates for the 2TS class of circuits. A schematic representation of the coincidence between idealized pre and post synaptic waveforms is shown in (11) and a schematic illustration of the corresponding hot electron injection is provided in (12).

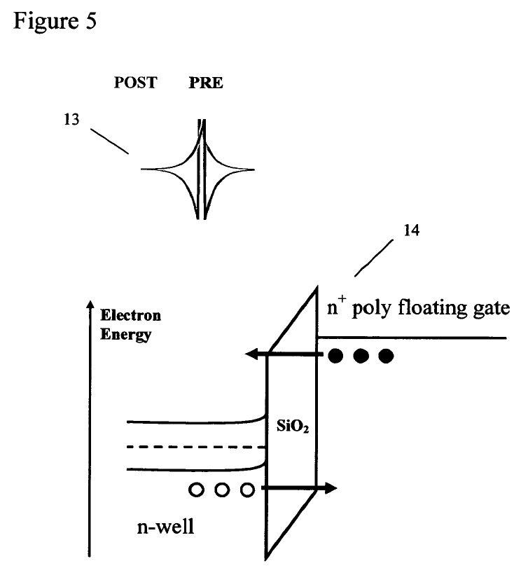

FIG. 5 illustrates one mechanism of implementing negative Hebbian weight updates for the 2TS class of circuits. A schematic representation of the coincidence between idealized pre and post synaptic waveforms is shown in (13) and a schematic illustration of the corresponding Fowler Nordheim tunneling is provided in (14).

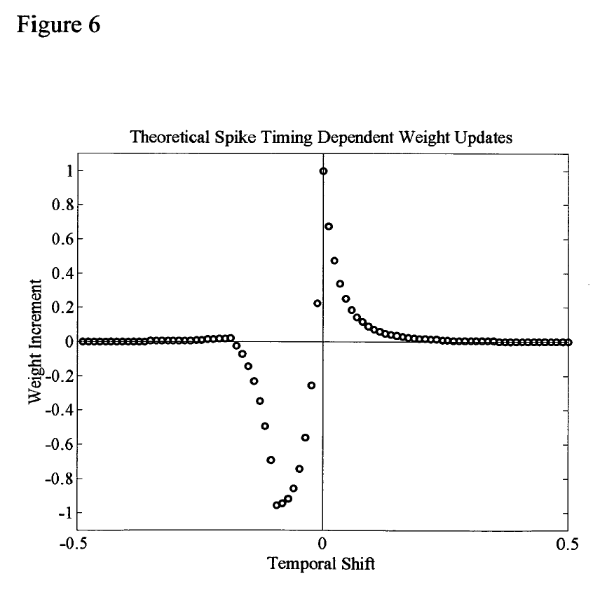

FIG. 6 represents a computation of theoretical weight updates resulting from different coincidences of idealized pre- and post-synaptic waveforms across one embodiment of the 2TS class of synapses. In FIG. 6, each point in the STDP curve represents the integration of the injection and tunneling contributions at a single instant in time as the PRE and POST waveforms are convolved past one another. For this simulation, both mechanisms were assumed to contribute currents and corresponding weight updates that increase exponentially beyond the relevant threshold voltage (source-drain voltage for injection and oxide voltage for tunneling). For simplicity, the exponential coefficients were taken to be the same for injection and tunneling although they differ in actual circuits. Likewise, tunneling and injection thresholds for these simulations were selected to balance the positive and negative weight updates and represent theoretical, rather than experimentally derived, estimates.

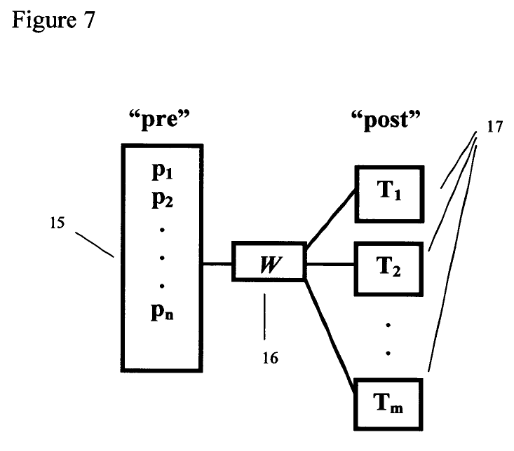

FIG. 7 represents a theoretical learning and pattern recognition neural network according to one embodiment of the present invention whose architecture corresponds roughly with fabricated circuit components. Input vector, p₁ . . . pₙ, (15) represents pre-synaptic signals, which may be neural spikes, or as here, simple vectors representing alphanumeric code. Weight matrix, W, (16) could correspond with an array of 2TS synapses. Distance estimators programmed with distinct template classes, T₁ . . . Tₘ, (17) may be used to generate post-synaptic “spikes” when computed template matches occur.

In one embodiment, the template classes (17) are programmed, and pre-synaptic input signals (15) may be weighted and correlated with each of the templates to assess whether there is a match. If so, the corresponding template can send a post-synaptic signal indicating a match that simultaneously reinforce and attenuates synapses in proportion to their contribution to the template match. In such a fashion, the weight matrix, or 2TS array (16), is proportionally strengthened and weakened according to the coincidence of pre- and post-synaptic activity. Moreover, after some number of iterations of programming, the weights themselves correspond with templates so that merely convolving incoming signals with the synaptic array should result in proper classification.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. An integrated circuit synapse comprising a first field effect transistor (“FET”) and a second FET, each transistor having a source, a drain and a gate region, wherein the gate regions of said FETs are electrically and/or physically connected;

2. The integrated circuit synapse of claim 1, wherein the FETs are metal oxide semiconductor field effect transistors (“MOSFETs”);

3. The integrated circuit synapse of claim 2, wherein the MOSFETs are p-type (“PFET”);

4. The integrated circuit synapse of claim 2, wherein at least one of the MOSFETs is n-type (“NMOS”);

5. The integrated circuit synapse of claim 1, wherein the source regions of said FETs are electrically and/or physically connected;

6. The integrated circuit synapse of claim 1, wherein the source region of said first field effect transistor is capacitively connected to said gate regions;

7. A method of implementing spike timing dependent plasticity (“STDP”) in integrated circuits comprising asserting a pre-synaptic signal at the source of the first FET of the integrated circuit synapse of claim 1, and asserting a post-synaptic signal at the drain of the first FET of the integrated circuit synapse of claim 1;

8. The method of claim 7, wherein the pre-synaptic signal comprises a first segment and a second segment, each segment having a beginning and ending point, said first segment comprising an exponentially increasing signal, said second segment comprising a signal whose value is computed by subtracting an exponentially decreasing value from a constant value, and wherein the ending point of said first segment is discontinuous with and of greater value than the beginning point of said second segment which is also the constant value, and where the concatenation of said first and second segments together represents the pre-synaptic signal;

9. The method of claim 8, wherein the post-synaptic signal comprises an inverted version of the pre-synaptic signal.

10. A method of implementing spike timing dependent plasticity (“STDP”) in a memristor comprising asserting a pre-synaptic signal at a first terminal of a memristor and a post-synaptic signal at a second terminal of a memristor.

11. The method of claim 10, wherein the pre-synaptic signal comprises a first segment and a second segment, each segment having a beginning and ending point, said first segment comprising an exponentially increasing signal, said second segment comprising a signal whose value is computed by subtracting an exponentially decreasing value from a constant value, and wherein the ending point of said first segment is discontinuous with and of greater value than the beginning point of said second segment which is also the constant value, and where the concatenation of said first and second segments together represents the pre-synaptic signal;

12. The method of claim 11, wherein the post-synaptic signal comprises an inverted version of the pre-synaptic signal.

13. The method of claim 7, wherein the pre- and post-synaptic signals comprise continuous time signals;

14. The method of claim 7, wherein the pre- and post-synaptic signals comprise continuous value signals;

15. The method of claim 7, wherein the pre- and post-synaptic signals comprise voltages;

16. The method of claim 10, wherein the pre- and post-synaptic signals comprise continuous time signals;

17. The method of claim 10, wherein the pre- and post-synaptic signals comprise continuous value signals;

18. The method of claim 10, wherein the pre- and post-synaptic signals comprise voltages;

19. The method of claim 10, wherein the pre- and post-synaptic signals comprise currents;

20. The method of claim 10, wherein the pre- and post-synaptic signals comprise electrochemical potentials.
